(19) United States
(12) Patent Application Publication
(10) Pub. No.: US 2026/0279036 A1
(43) Pub. Date: Sep. 17, 2026

(54) Neural Data Compression with Masked Transformer Models

(71) Applicant: Google LLC, Mountain View, CA (US)

(72) Inventors: Michael Tobias Tschannen, Zürich (CH); Eirikur Thor Agustsson, Reykjavik (IS); Fabian Julius Mentzer, Zürich (CH)

(21) Appl. No.: 19/470,695

(22) PCT Filed: Mar. 28, 2024
(86) PCT No.: PCT/US2024/021895

§ 371 Date: Sep. 29, 2025

Related U.S. Application Data
(60) Provisional application No. 63/492,654, filed on Mar. 28, 2023.

(51) Int. Cl. G06V 10/82; G06N 3/0495

(52) U.S. Cl. CPC G06V 10/82; G06N 3/0495

(57) ABSTRACT

Provided are systems and methods that train masked transformer models to perform neural data compression (e.g., image compression). According to one example aspect, instead of relying upon a complex multi-scale model that uses a hyperprior, example implementations of the present disclosure can use a single-scale transformer model that does not use a hyperprior, such as, for example, a standard transformer or similar variants. This greatly simplifies the model architecture and enables improvements in inference speed. According to another example aspect, instead of an uncertainty-adaptive approach recently used for image generation, example implementations of the present disclosure can use predefined, deterministic schedules. The use of deterministic schedules enables the use of masked attention during training (e.g., in addition to masked inputs).

### RELATED APPLICATIONS

This application claims priority to and the benefit of U.S. Provisional Patent Application No. 63/492,654, filed Mar. 28, 2023. U.S. Provisional Patent Application No. 63/492,654 is hereby incorporated by reference in its entirety.

### FIELD

The present disclosure relates generally to data compression, such as image compression. More particularly, the present disclosure relates to neural data compression with masked transformer models.

### BACKGROUND

Neural data compression refers to the application of neural networks and other machine learning methods to data compression. As one example, lossy neural image compression is an active field of research, with advancements being made on two fronts: Entropy models (e.g., how to losslessly code a lossy, quantized representation of the image) and transforms (e.g., how to encode/decode the representation from/to pixels).

Recently, transformer models have been investigated both for the entropy models and the transforms. In particular, previous work has used masked and unmasked transformers in the entropy model for video compression and image compression. However, these models are often either prohibitively slow, or lag in rate-distortion performance.

In a separate line of research, transformer models have been previously used for image generation by progressively sampling groups of masked tokens according to uncertainty-adaptive schedules.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for performing neural data compression with improved efficiency. The method includes obtaining, by a computing system comprising one or more computing devices, a plurality of feature tokens associated with a dataset. The method includes training, by the computing system, a masked transformer model on the plurality of feature tokens to learn a distribution associated with the plurality of feature tokens, wherein the masked transformer model comprises a single-scale transformer model that does not use a hyperprior. The method includes using, by the computing system, the trained masked transformer model to predict one or more distribution parameter values for each of the plurality of feature tokens. The method includes entropy coding, by the computing system, the plurality of feature tokens based on the one or more distribution parameter values predicted by the trained masked transformer model.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example framework for performing neural data compression according to example embodiments of the present disclosure.

FIG. 2 depicts a graphical diagram of example location schedules according to example embodiments of the present disclosure.

FIG. 3 depicts a graphical diagram of example model training processes according to example embodiments of the present disclosure.

FIG. 4 depicts a graphical diagram of example model inference processes according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

The present disclosure is directed to systems and methods that train masked transformer models to perform neural data compression (e.g., image compression). More generally, an example framework for performing neural data compression can include application of a lossy transform to an input dataset to generate a discrete representation and then use of an entropy model to compress this discrete representation losslessly. Example implementations of the present disclosure focus on the entropy modeling aspect. In particular, according to one example aspect, instead of relying upon a complex multi-scale model that uses a hyperprior, example implementations of the present disclosure can use a single-scale transformer model that does not use a hyperprior, such as, for example, a standard or “vanilla” transformer or similar variants. This greatly simplifies the model architecture and enables improvements in inference speed. According to another example aspect, instead of an uncertainty-adaptive approach recently used for image generation, example implementations of the present disclosure can use predefined, deterministic schedules. The use of deterministic schedules enables the use of masked attention during training (e.g., in addition to masked inputs). The use of deterministic schedules also enables activation caching during inference. These techniques significantly speed up the proposed models (e.g., ~4x higher inference speed) at a small increase in bitrate.

More particularly, example implementations of the present disclosure leverage the fact that various types of machine learning models can be optimized to minimize the cross entropy between a token distribution p modeled by the machine learning model and a true (unknown) token distribution q, for example as measured via negative log likelihood (NLL). This is equivalent to the bit cost required to (losslessly) store a sample drawn from q with a model p. Indeed, any model p that predicts an explicit joint distribution over tokens in a deterministic way can be turned into a compression model by using p to entropy code the tokens, rather than sampling them.

In view of this insight, some example implementations of the present disclosure employ masked transformers for neural data compression (e.g., neural image compression). In particular, the present disclosure provides a conceptually simple transformer-based approach that is state-of-the-art in neural image compression, at practical runtimes. The proposed framework is capable of using off-the-shelf transformers and, in contrast to previous work, does not rely on special positional encodings or multi-scale factorizations.

Additionally, the present disclosure proposes a new model variant that masks both the input and attention layers, and allows a neural data compression system to substantially improve runtimes at a small cost in rate-distortion.

In some implementations, to train the masked transformers, the tokens to be masked in each training step can be selected uniformly at random and the model can be trained to predict the masked tokens.

However, during inference, the models can first be applied to masked tokens only, predicting a distribution for every single token. A sample can then be drawn from this distribution and a subset of tokens can be uncovered at the input. This step can be repeated until no mask tokens remain.

Two important questions arise: (i) How many tokens should be sampled in every step, and (ii) Which spatial locations should be chosen.

One possible solution to (ii) is to use an instance-adaptive scheme in which every sampled image will have a different schedule of locations. For example, in MaskGIT, the authors use a VQ-GAN to map images to vector-quantized tokens, and learn a transformer to predict the distribution of these tokens for the purpose of image generation (not compression). See Chang et al., Maskgit: Masked generative image transformer. In Proceedings of the IEEE/CVF Conference on Computer Vision and Pattern Recognition, pages 11315-11325, 2022.

The key novelty of the MaskGIT approach was to use BERT-like random masks during training to then predict tokens in groups during inference, sampling tokens in the same group in parallel at each inference step. In such fashion, each inference step is conditioned on the tokens generated in previous steps. A big advantage of BERT-like training with grouped inference versus prior state of the art is that considerably fewer steps are required to produce realistic images (typically 10-20, rather than one per token).

However, the present disclosure demonstrates that in terms of NLL (and thus bitrate), a deterministic schedule performs just as well, and furthermore provides a number of additional benefits as compared to an adaptive schedule. In particular, the use of a deterministic schedule enables example implementations of the present disclosure to adopt and improve aspects of fully autoregressive transformer decoders like the original model proposed by Vaswani et al., Attention is all you need. Advances in Neural Information Processing Systems 30 (2017).

In particular, example implementations bridge between fully autoregressive and instance-adaptive transformers as follows: In autoregressive models, the input sequence is shifted by one token to the right, causing the outputs to align in a casual way; that is, the i-th output is trained to predict the i−1-th input. This can be thought of as a “group-autoregressive” schedule with group size equal to 1. Example implementations of the present disclosure generalize this idea to group sizes >1. In particular, some example implementations of the present disclosure can permute the input such that the model can uncover it group by group from left to right. Similarly, the targets can be permuted such that each group at the input predicts the next group at the output.

To accommodate a sequence of increasing group size (which leads to the best generation/compression performance in practice), some example implementations can insert mask tokens at the input to pad the i−1-th group to the length of the i-th group. During inference, this allows the model to initially run on very few tokens, and then more and more. This is in contrast to approaches that always feed the same number of tokens into the model.

One example implementation of the models described herein can be referred to as MT. MT is a standard or “vanilla” MaskGIT-like transformer that obtains state-of-the art neural image compression results. In contrast to previous work, the MT model represents a conceptually clean approach that relies on standard transformers applied to tiles. MT does not require a multi-scale model (e.g., with “hyperprior”) and the corresponding compression system can span a large bitrate regime by using scalar quantization.

Another example implementation of the models described herein can be referred to as M2T. In particular, MT can be sped up by masking the transformer twice: both at the input and in the attention layers, thereby creating an M2T model. The M2T model is faster because it is applied to fewer tokens and because the attention masks make the transformer causal, allowing for caching of activation values. Together, this leads to >3.6× runtime improvements as measured on accelerators, vs. a MaskGIT-like model.

Thus, the present disclosure provides a number of advances that enable the application of masked transformer models to neural image compression. The proposed approaches provide a number of technical effects and benefits. For example, the proposed framework enables the use of a single-scale transformer, rather than a multi-scale transformer with hyperprior. This reduces the complexity of the model and improves the speed with which the model can perform inference. As another example technical effect, some example implementations can use attention masking to enable activation value caching. Caching of activation values can reduce the number of computations that need to be performed, thereby conserving computational resources such as processor cycles. Certain model variants can also reduce the average compute per output token as the model processes fewer tokens in total, at a small cost in bitrate.

With reference now to the Figures, example embodiments of the present disclosure will be discussed in further detail.

### Example Neural Data Compression Approaches

### Example Neural Data Compression Framework

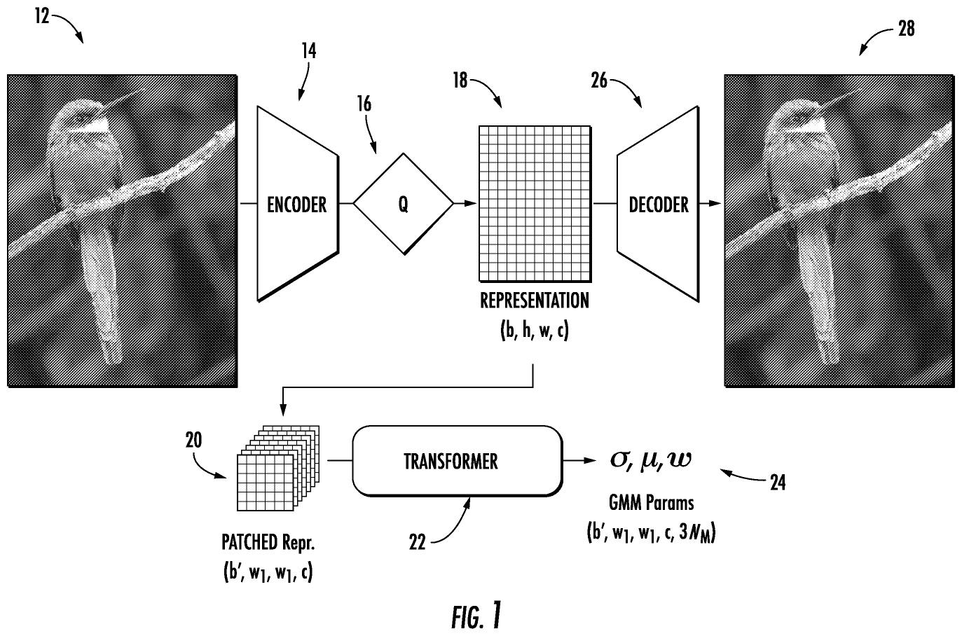

A high level overview of an example of the proposed approach is shown in FIG. 1. As illustrated in FIG. 1, a computing system can obtain a dataset 12 to be compressed. As one example, the dataset 12 can include one or more images. For example, the images can be formatted according to any digital image format. For example, the images can include multiple images organized as a batch. In other examples, the dataset 12 can include files or other forms of data.

An encoder model 14 can process the input dataset 12 to generate a plurality of intermediate feature values (which are not explicitly shown in FIG. 1). The computing system can perform quantization (shown as operation Q at 16) on the plurality of intermediate feature values to generate a plurality of quantized feature tokens 18.

To provide an example, given an input dataset 12 that includes an H×W image, the computing system can apply an encoder E 14 to obtain intermediate features of shape ([H/16], [W/16], c). The computing system can quantize 16 the intermediate features element-wise (e.g., scalar quantization), yielding the quantized feature representation y=Q(E(x)) (shown at 18). As an example, the quantized feature representation 18 can be a discrete representation of shape (b, h, w, c) and can contain a plurality of quantized feature tokens.

As a general matter, from the quantized feature representation y 18, it is possible to get a reconstruction 28 of the original dataset 12 by processing the quantized feature representation y 18 with a decoder model D (shown at 26). Namely, the reconstruction 28 can be notated as follows: \hat{x}=D(y).

Since in general, \hat{x}≠x, the encoder 14 and decoder 26 can together be referred to as a lossy auto-encoder. This lossy auto-encoder can be transformed into a lossy image compression scheme by storing y to disk losslessly. For example, one naive approach is to store every element in y independently with, e.g., an int32, resulting in a method that uses 32c/16² bits per pixel (bpp). However, this results in a very poor compression ratio.

As an alternative, according to an aspect of the present disclosure, a transformer model 22 can be used to perform neural compression on the plurality of quantized feature tokens included in the quantized feature representation 18. In particular, the transformer model 22 can be used to model and predict a (discrete) distribution P(y). Entropy coding can then be used to store y to disk using ≈Σᵢ−log₂P (yᵢ) bits (intuitively, more likely symbols should be stored with fewer bits).

To provide an example of this process, referring still to FIG. 1, the quantized feature representation 18 can then be split into patches 20 of size w_{T} (e.g., folded into the batch dimension, so that b′=b·hw/

$${w}_{T}^{2} ) .$$

The computing system van then entropy code each of these patches 20 independently (and possibly in parallel) using the distributions predicted by the transformer model 22. As an example, as discussed further below, the transformer model 22 can be parameterized by a mixture of Gaussians (GMM) with N_{M}=3 mixtures.

In particular, the computing system can train the transformer model 22 on the patches of feature tokens 20 to learn the distribution associated with the patches of feature tokens 20. As one example, the transformer model 22 can be a masked single-scale transformer model that does not use a hyperprior.

Next, the computing system can use the trained masked transformer model 22 to predict one or more distribution parameter values 24 for each of the feature tokens included in one of the patches 20. The computing system can entropy code the quantized feature representation 18 based on the one or more distribution parameter values 24 predicted by the trained transformer model 22.

After entropy coding, the compressed version of the representation 18 can be stored in a computer memory, transmitted between computing devices, etc. When desired, the entropy coding can be reversed (decoded) to losslessly produce the representation 18. The decoder 26 can then process the representation 18 to obtain the reconstruction 28 of the dataset 12.

It should be noted that while FIG. 1 shows the example framework applied to patches of quantized feature tokens, the proposed transformer model 22 and associated framework can be applied to any other form of feature tokens (e.g., intermediate feature tokens) or any other tokenized data representation for which neural compression is desired.

### Example Autoencoder and Tokenization

One example implementation for the encoder 14 and the decoder 26 is to use the convolutional ELIC encoder/decoder proposed by He et al., with 256 channels for all layers except for the last layer of the encoder which predicts the c-dimensional representation. See He et al., ELIC: Efficient Learned Image Compression with Unevenly Grouped Space-Channel Contextual Adaptive Coding. In CVPR 2022.

In some examples: c=192 and the encoder E 14 can downscale by a factor 16. The following notation can be used as shorthand: h=[H/16], w=[W/16]. In some implementations, if the dimensions of an input dataset (e.g., image) do not divide by 16 during inference, the computing system pad the input dataset, calculate the padded reconstruction and bitrate, and then unpad at the output. To get gradients through the quantization operation, some example implementations rely on straight-through estimation (STE).

In some implementations, the proposed framework does not consider each of the h·w·c elements in this representation as a token, since this would yield infeasibly long sequences for transformers (e.g., a 2000× 2000px image turns into a representation with 125×125×192=3M symbols). Instead, some example implementations group each 1×1×c column into a “token”, which results in hw tokens of dimension c each.

### Example Transformers

Some example implementations use a standard transformer encoder in the pre-norm setup with the Base (“B”) configuration (12 attention layers, width 768, and MLPs with hidden dimension 3078). See, e.g., Dosovitskiy et al., An image is worth 16×16 words: Transformers for image recognition at scale. arXiv preprint arXiv: 2010.11929, 2020 and Xiong et al., On layer normalization in the transformer architecture. In International Conference on Machine Learning, pages 10524-10533. PMLR, 2020.

Some example implementations can apply two compression-specific changes: since one possible input is a vector of c scalar-quantized integers, the standard dictionary lookup-based embedding typically cannot be used (as the vocabulary size is theoretically infinite). Instead, some example implementations can normalize the vectors by dividing with a small constant (e.g., δ=5) and apply a dense layer shared across tokens to function as the “embedding layer”.

Similarly, at the output, the proposed framework typically does not predict a finite number of logits. Rather, some example implementations model each entry of a token using a continuous, parametrized distribution, which is then quantized to a PMF as described below. As an example, some example implementations use a mixture of Gaussians (GMM) with N_{M}=3 mixtures, each parameterized by a mean μ, scale σ, and weight w.

Patched inference: For standard transformers, a positional embedding is typically learned for every input token, and this can also be applied to the proposed models. This means that these example models are not applicable to arbitrary resolutions during inference without carefully adapting the positional embedding, which often involves finetuning on the target resolution. However, for image compression, datasets of widely varying image size are the norm. To reconcile this, the present disclosure proposes a simple solution: example implementations of the framework apply the transformer on patches of w_{T}×w_{T} tokens. In one example, w_{T}=24 since this corresponds to full representation size during training (one example can use 384px crops during training, yielding h=w=24). Since some example implementations use the transformer for losslessly coding the representation, this technique does not cause any boundary artifacts. The only downside is that some correlations across patches are not leveraged to drive down the bitrate even further. Concretely, this implies the flow of tensors shown in FIG. 1 during inference.

Note the simplicity of the proposed scheme, using off-the-shelf transformers in a patched manner. In contrast to certain other approaches, the proposed techniques do not have to adapt the attention mechanism or use a relative positional embedding. This means that the proposed approach will benefit from future research into speeding up standard transformers.

### Example Masking Schedules

The proposed framework is flexible to include or apply various different masking schedules. A masking schedule is a sequence of masks [symbol] ={M₁, . . . , M_{S}}, where S is the number of masks (or, equivalently, inference steps), and each tensor Mᵢ is a binary mask tensor of length

$${w}_{T}^{2} .$$

Mᵢ[j]=1 indicates that the j-th token is predicted and uncovered at step i. As outlined in the overview, there are two important axes when building [symbol] besides the number of masks S:
1. Group Size Schedule: How many token are uncovered in each step, i.e., what is Σⱼ Mᵢ[f]∀i.
2. Location Schedule: Which tokens are chosen to be uncovered, i.e., which indices in each Mᵢ are set to 1.

Some example implementations parameterize the “group size schedule” via the cumulative number of tokens that are uncovered after x steps using a strictly monotonically increasing function ƒ(x). Some example masking schedules correspond to a power schedule, i.e., ƒ(x)=N_{S,α}x^{α}, where α controls how fast the model uncovers, and N_{S,α} normalizes such that the model uncovers all

$${w}_{T}^{2}$$

tokens in S steps.

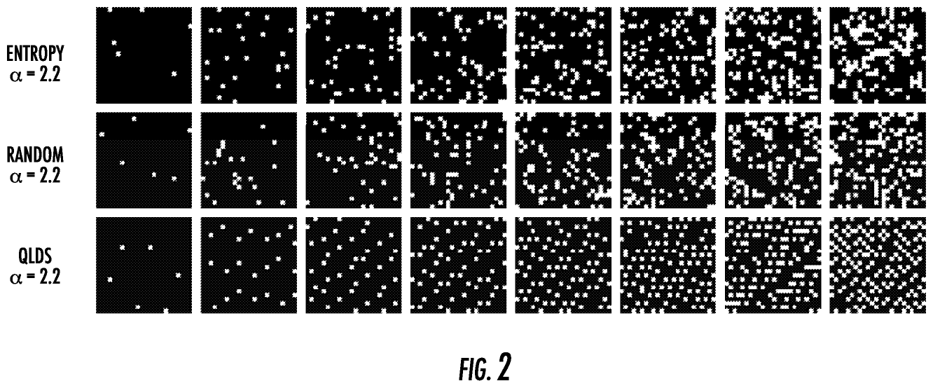

For “location schedules”, a number of different options can be used, three examples of which are visualized at the top of FIG. 2. One example location schedule is an entropy-based schedule. In one example of an entropy-based schedule: in the i-th step, the model is applied to the current input, a distribution pⱼ is predicted for every masked token, and a value xⱼ is sampled for every masked location j. The “confidence score” of xⱼ is obtained as pⱼ(xⱼ) and a number of tokens (governed by the group size schedule) with the highest confidence score is retained. This also determines the masked locations of the next step i+1. For compression, since one aim to produce short bitstreams, and the bitrate is a function of the predicted entropy, this schedule can be adapted to our use case by retaining tokens with the lowest entropy instead of the confidence score.

A second example schedule is called random, where a seed is fixed and locations are sampled uniformly at random (with a fixed seed). This is motivated by the fact that this mimics the training distribution of mask locations.

A third example schedule is a novel schedule proposed herein, QLDS (“quantized low-discrepancy sequence”), which is loosely motivated by information theory: Note that at every step i, the computing system entropy codes the tokens in the i-th group in parallel, and conditionally on the tokens of all previous groups (this is possible, as these tokens will be available in the i-th decoding step). Hence, to get good prediction of all available at tokens in the i-th group, the mutual information between the i-th group and all previous groups should be maximized. At the same time, all tokens within a group are encoded in parallel, and the system can thus not leverage their mutual information, meaning the schedule should minimize the mutual information within groups. For images the computing system can use distance in pixel space as a proxy for mutual information, since we expect nearby pixels to be more correlated than pixels far apart. Intuitively, this implies that tokens within a given group should be far from each other spatially, and at the same time close to tokens in previous groups.

To this end, some example implementations use low-discrepancy sequences (LDS), which are described in Chapter 2 of Lauwerens Kuipers and Harald Niederreiter. Uniform distribution of sequences. Courier Corporation, 2012. LDS are pseudo-random sequences that minimize the “discrepancy” for any subsequence, meaning among other things that when the sequence is cut off at an arbitrary index i, all elements up to i are close to evenly distributed. An LDS in 2D is given by a sequence of points X=x₁, . . . , x_{N}. This can be turned into a masking schedule by specifying K group sizes that sum to N, and then simply splitting X into K groups. The fact that X is an LDS implies the desired properties mentioned above, e.g., all points in a group are far from each other, while at the same time merging all groups up to a certain step yields a set of points that near-uniformly cover the space.

### Example Masking Model 1: MT

For MT a masked transformer can be used.

Example MT Training: Given the representation y=E(x), a computing system can randomly sample a mask M for every batch entry, which is a binary vector of length

$${w}_{T}^{2} ,$$

where 5-99% of the entries are 1. The corresponding entries in y are masked, which means that they are replaced with a special mask token (this is a learned c-dimensional vector). The resulting tensor, y_{M}, is fed to the transformer, which predicts distributions of the tokens. Each distribution is factorized over the c channels. Only the distributions corresponding to the masked tokens are considered to compute the loss, e.g.,

$${ℒ}_{M T} = {𝔼}_{y \sim {p}_{y} , u \sim {𝒰}_{\pm 0.5}} [ {\sum }_{\begin{matrix}i ∈ \{ 1 , … , {w}_{T}^{2} \} , \\ M [ i ] = 1\end{matrix}} - {log}_{2} p ( {y}_{i} + u \vert {y}_{M} ) ] , \qquad ( 1 )$$

where additive i.i.d. noise is used to simulate quantization during training. Here, the standard trick of integrating the continuous distribution p produced by the model on unit-length intervals can be used to obtain:

$$P ( y ) = {\int }_{y - \frac{1}{2}}^{y + \frac{1}{2}} p ( u ) d u , y ∈ ℤ .$$

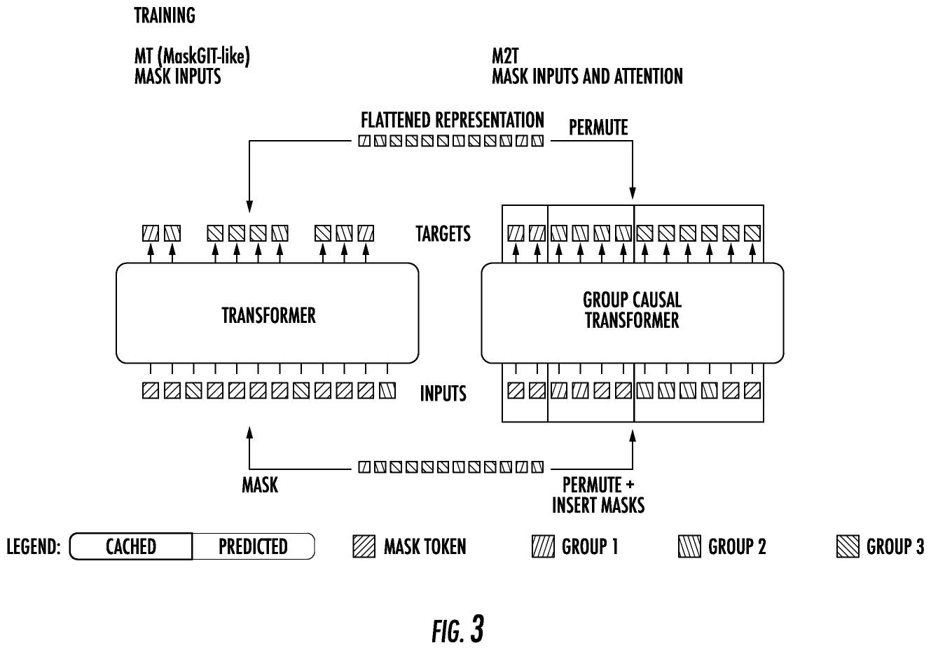

An example of this process is shown in the flow on the left side of FIG. 3. In particular, FIG. 3 illustrates training, shown for 12 tokens only.

Example MT Inference: For inference, the model can be applied S times following one of the schedules outlined above. In some implementations, in the first iteration, the computing system only feeds mask tokens, then the computing system entropy codes the tokens corresponding to M₁, uncovers them at the input, and repeats until all tokens have been entropy coded.

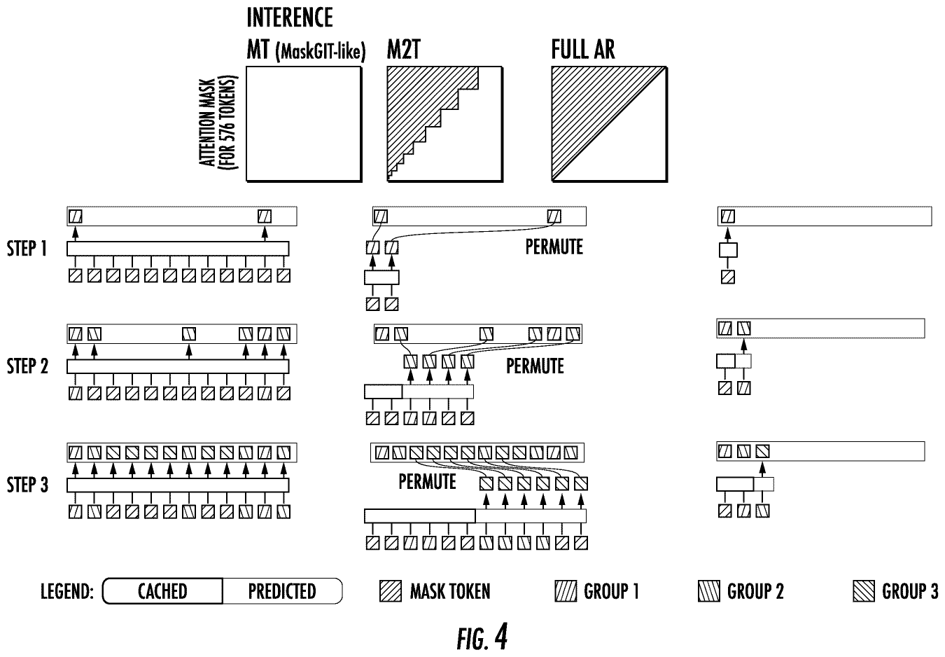

An example of this process is shown in the left-most portion of FIG. 4. Specifically, the top of FIG. 4 shows the attention masks and the portions below show the first three inference steps for each model type. The far-left side is the MaskGIT-like approach MT, where the attention is not masked, and the same number of tokens is fed in each step.

### Example Masking Model 2: M2T

According to an aspect of the present disclosure, a deterministic schedule can be used for inference without hurting bitrate. This motivates a proposed fast model that masks twice: once at the input, once in the attention, which can be called M2T.

Recall that fully autoregressive transformer decoders like the original approach by Vaswani use a diagonal attention mask during training to enforce causality. This idea can be generalized as follows. Given a sequence of masks [symbol] , some example implementations can construct i) a permutation of the input, ii) attention masks, iii) a permutation of the targets, which together allow the computing system to get the complete token distribution with a single forward pass during training, and also allow the computing system to do fast inference.

As visualized in FIG. 3 right-side and FIG. 4 center column, the computing system can form (i) the permuted inputs by constructing | [symbol] | groups, where the i-th group consists of the tokens in group Mᵢ₋₁ followed by mask tokens to pad the subsequence to length ΣMᵢ. [symbol] also induces (ii) an attention mask A, a “block triangular” matrix (see the mask shown for M2T in FIG. 4) which ensures causal dependence structure across groups. Finally, (iii) the permutation of the targets is simply putting tokens of the same group next to each other.

Thus, in the M2T approach, and as shown in FIG. 3 right side, each input group corresponds to the previous output group with additional mask tokens to align groups of different sizes. The group causal transformer is using attention masking. Further, as shown in FIG. 4 center column, both the attention and the input is masked, and the input is uncovered one group at a time. The causal masks used in the attention allow the computing system to cache activations, e.g., for shaded regions the system can cache. Together with the fewer tokens fed in each (but last) step, this significantly speeds up the model.

It should be noted that mask tokens at the input enable nonlinear schedules where the current step predicts more tokens than the previous step, by simply padding the previously predicted/decoded tokens at the input to the length of the output of the current step. Further, masking the attention turns the model into a causal transformer which allows teacher forcing during training, e.g., all steps can be trained simultaneously for the known target token sequence. This also enables caching at inference time.

Further note that this scheme is a generalization of full autoregressive training with attention masks: It can be recovered with a sequence of masks [symbol] = {[1,0, . . . ], [0,1, . . . ], . . . , [ . . . ,0,1]} that uncover the latent in raster scan order. Using this, groups of size 1 are obtained, and the standard triangular A follows (see FIG. 4, mask shown for “Full AR”). According to an example implementation of the algorithms outlined above, some example implementations can insert only a single mask token at the start of the input. This corresponds to the START token typically used with fully autoregressive models.

In particular, FIG. 4 shows the fully autoregressive (Full AR) approach for reference, as employed, e.g., in the standard transformer decoder. The M2T approach is a generalization that allows for group sizes greater than one.

Example M2T Training: During training, some example implementations can apply the components above: (i) permute the input, obtaining yᵢₙ, (ii) feed it to the transformer masked with attention masked by A, and (iii) get the permuted output yₒᵤₜ, yielding

$${ℒ}_{M 2 T} = {𝔼}_{y} [ - {log}_{2} p ( {y}_{o u t} \vert {y}_{i n} ) ] \qquad ( 2 )$$

In contrast to the example loss for MT shown at Eq. 1, the example loss of Eq. 2 corresponds to the bitrate required to compress the full y.

Example M2T Inference: For inference, some example implementations feed slices of the input as shown in the center column of FIG. 4. The computing system can cache activations for the tokens that were previously fed, which works thanks to the causality induced during training with A.

### Example Loss

Some example implementations can train the autoencoder and transformer jointly end-to-end, minimizing the rate-distortion trade-off r(y)+λd(x, \hat{x}). For example, either [symbol] _{MT} or [symbol] _{M2T} can be used for r(y) and MSE can be used for d. The hyperparameter A controls the trade-off between the bitrate and distortion.

### Example Devices and Systems

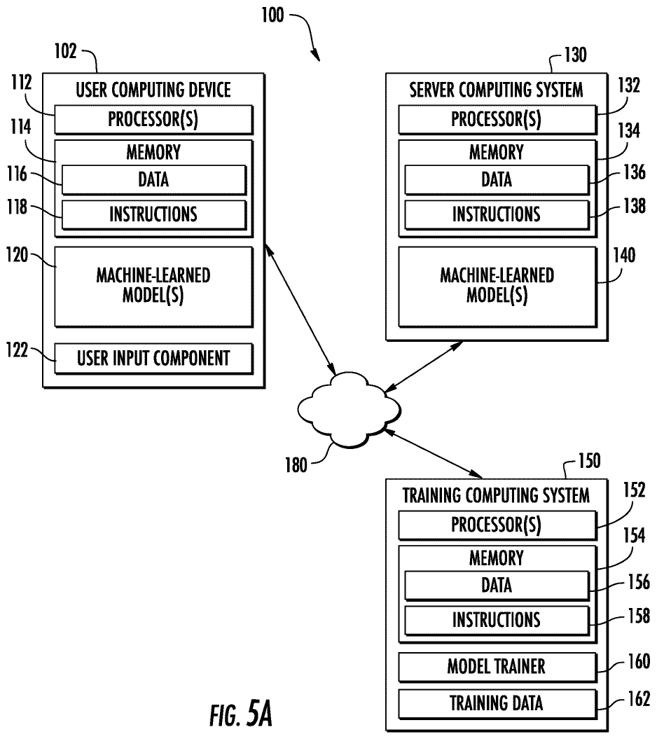

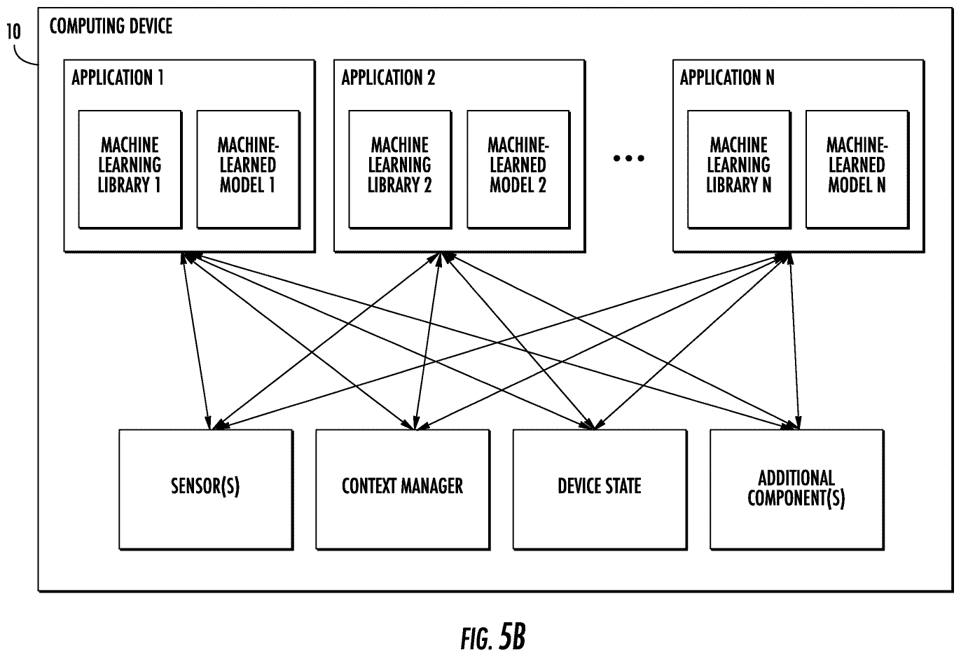

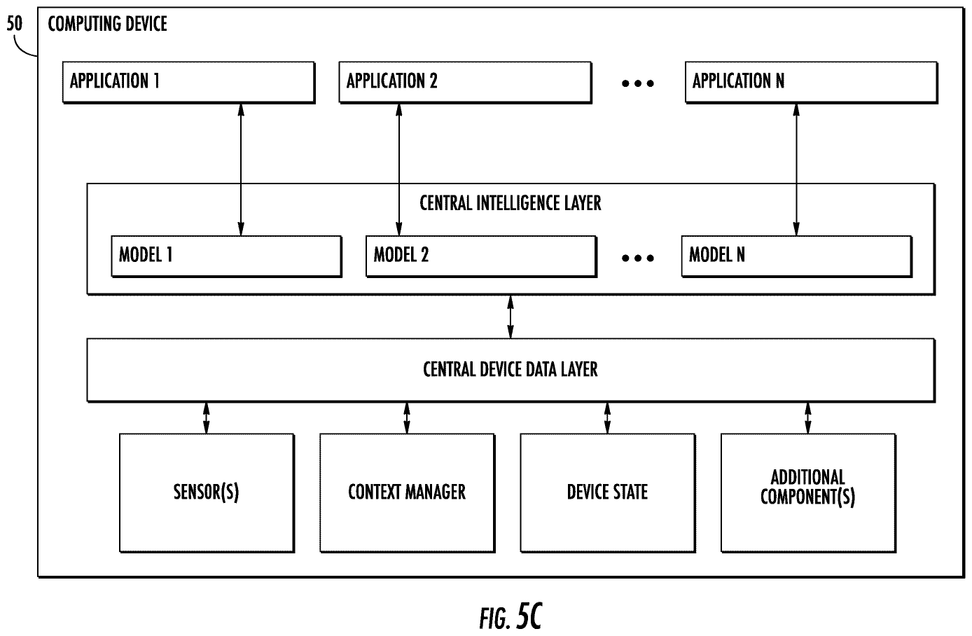

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel data compression across multiple instances of datasets).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a data compression service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API).

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for performing neural data compression with improved efficiency, the method comprising:
obtaining, by a computing system comprising one or more computing devices, a plurality of feature tokens associated with a dataset;
training, by the computing system, a masked transformer model on the plurality of feature tokens to learn a distribution associated with the plurality of feature tokens, wherein the masked transformer model comprises a single-scale transformer model that does not use a hyperprior;
using, by the computing system, the trained masked transformer model to predict one or more distribution parameter values for each of the plurality of feature tokens; and
entropy coding, by the computing system, the plurality of feature tokens based on the one or more distribution parameter values predicted by the trained masked transformer model.

2. The computer-implemented method of claim 1, wherein the dataset comprises one or more images.

3. The computer-implemented method of claim 1, wherein the masked transformer model does not use positional encoding.

4. The computer-implemented method of claim 1, wherein the masked transformer model uses both token and attention masking.

5. The computer-implemented method of claim 4, wherein the masked transformer model uses a causal mask for the attention masking.

6. The computer-implemented method of claim 5, wherein using, by the computing system, the trained masked transformer model to predict the one or more distribution parameter values for each of the plurality of feature tokens comprises:
iteratively predicting the one or more distribution parameter values over two or more iterations; and
caching activation values of the trained masked transformer model at each iteration for use in a subsequent iteration.

7. The computer-implemented method of claim 1, wherein using, by the computing system, the trained masked transformer model to predict the one or more distribution parameter values for each of the plurality of feature tokens comprises predicting the one or more distribution parameter values for each of the plurality of feature tokens according to a masking schedule.

8. The computer-implemented method of claim 7, wherein the masking schedule comprises a group size schedule that indicates a plurality of group sizes respectively for a plurality of groups that are sequentially predicted, wherein at least one group size of the plurality of group sizes is two or greater.

9. The computer-implemented method of claim 8, wherein the plurality of group sizes are monotonically increasing.

10. The computer-implemented method of claim 7, wherein the masking schedule comprises a deterministic masking schedule.

11. The computer-implemented method of claim 7, wherein the masking schedule comprises a location schedule that indicates a plurality of locations respectively for a plurality of groups that are sequentially predicted.

12. The computer-implemented method of claim 11, wherein the location schedule comprises a quantized low-discrepancy sequence.

13. The computer-implemented method of claim 1, wherein the plurality of feature tokens associated with the dataset comprise a plurality of quantized feature tokens, the plurality of quantized feature tokens generated by quantization of a plurality of intermediate feature values output by a machine-learned encoder model when supplied with the dataset.

14. (canceled)

15. (canceled)

16. A computing system configured to perform neural data compression with improved efficiency, the computing system comprising one or more processors and one or more non-transitory computer-readable media that collectively store instructions that, when executed by the one or more processors, cause the computing system to perform operations, the operations comprising:
obtaining, by the computing system, a plurality of feature tokens associated with a dataset;
training, by the computing system, a masked transformer model on the plurality of feature tokens to learn a distribution associated with the plurality of feature tokens, wherein the masked transformer model comprises a single-scale transformer model that does not use a hyperprior;
using, by the computing system, the trained masked transformer model to predict one or more distribution parameter values for each of the plurality of feature tokens; and
entropy coding, by the computing system, the plurality of feature tokens based on the one or more distribution parameter values predicted by the trained masked transformer model.

17. The computing system of claim 16, wherein the dataset comprises one or more images.

18. The computing system of claim 16, wherein the masked transformer model does not use positional encoding.

19. The computing system of claim 16, wherein the masked transformer model uses both token and attention masking.

20. One or more non-transitory computer-readable media that collectively store:
a masked transformer model that has been trained on a plurality of feature tokens associated with a dataset,
wherein the masked transformer model has learned a distribution associated with the plurality of feature tokens, and
wherein the masked transformer model comprises a single-scale transformer model that does not use a hyperprior; and
instructions that, when executed by the one or more processors of a computing system, cause the computing system to perform operations, the operations comprising:
using, by the computing system, the trained masked transformer model to predict one or more distribution parameter values for each of the plurality of feature tokens; and
entropy coding, by the computing system, the plurality of feature tokens based on the one or more distribution parameter values predicted by the trained masked transformer model.

21. The one or more non-transitory computer-readable media of claim 20, wherein the dataset comprises one or more images.

22. The one or more non-transitory computer-readable media of claim 20, wherein the masked transformer model does not use positional encoding, and wherein the masked transformer model uses both token and attention masking.
